(19) United States
(12) Patent Application Publication
(10) Pub. No.: US 2016/0314299 A1
(43) Pub. Date: Oct. 27, 2016

(54) Mobile Device with Improved Security

(71) Applicant: David Almer, Rehovot (IL)

(72) Inventor: David Almer, Rehovot (IL)

(21) Appl. No.: 15/101,936

(22) PCT Filed: Dec. 9, 2014
(86) PCT No.: PCT/IL14/51073

§ 371 Date: Jun. 6, 2016

(30) Foreign Application Priority Data
Dec. 10, 2013 (IL) 229907

(51) Int. Cl. G06F 21/57; G06F 17/30; H04L 29/06; G06F 21/60; G06F 21/56

(52) U.S. Cl. CPC G06F 21/57; G06F 21/602; G06F 21/56; H04L 63/0428; G06F 17/30312; G06F 17/30584; G06F 2221/031

(57) ABSTRACT

A security system for operating mobile devices safely. Three partitions are created and managed: an enterprise partition for running, enterprise applications, a personal partition for running sensitive personal applications, and a generic partition for running generic applications. The system manages the different partitions to make sure which applications can be installed in each partition, and make sure that no application can access data outside its partition or access resources it is not authorized to access.

### TECHNICAL FIELD

The present invention relates in general to mobile devices with improved security and privacy protection and in particular to mobile devices with separate environments (partitions) for running enterprise applications, sensitive personal applications and general applications.

### BACKGROUND ART

The worldwide deployment of communication and computing mobile devices (smartphones, tablets, laptops) and the continuous improvement in the user experience and device capabilities (computing power, screen size and resolution, wireless communication speed, Global Positioning Systems (GPS), camera, Near Field Communications (NFC) and other embedded components) make them an ideal platform for dual use as an enterprise mobile access device and as a personal mobile computing, communications and entertainment device. The use of mobile devices in the enterprise space is expected to significantly improve the productivity of mobile workers. Mobile devices also increase the collaboration within the enterprise and with clients and suppliers/partners.

The ubiquity and performance of wireless Internet channels also create an opportunity for mobile subscribers to access a large set of personal services from any location and at any time. These personal services are provided by both generic and entertainment applications (news, games, navigation, location-dependent services, multimedia, etc.) and specialized, sensitive applications in regulated domains (financial, healthcare, e-Government, Internet commerce, cloud computing services, social networks, etc.). The later usually authenticates the mobile subscriber with a username and password, and in special cases using strong authentication that also needs a biometric and/or a security token device. The growth in the number of cyber-attacks against mobile devices and the increase in their sophistication and the generated damage create security concerns within the IT departments of enterprises and cellular and content service providers. The mobile subscribers desire to enjoy the anytime, anywhere computing experience without security and privacy concerns, as well as a friendly and secure mechanism to access their growing number of mobile apps.

The current solutions for Enterprise Mobility Management Systems use standard (non-virtualized) commercial mobile devices connected to the enterprise using a MDM/MAM/MCM (Mobile Devices/Applications/Content Management) paradigm—see typical examples from MobileIron™, Airwatch™, Fiberlink™, Citrix™, Good Technology™, Blackberry™ et al.). They contain a centralized mobility management subsystem and a mobile client software component installed on the mobile devices that controls and monitors their configuration, enterprise applications set and the rules of access to the enterprise services, networks and servers. The major mobile devices manufacturers (Apple™, Samsung™, Blackberry™) support this approach by implementing as much as possible of the mobile client functions directly into their operating systems. The main purpose of the MDM systems is to provide a mobile environment that protects the enterprise services, networks and servers against cyber-attacks via the mobile devices and prevents the loose of sensitive enterprise data and, to a lesser extent, protects the security and privacy of the mobile subscriber personal data.

Another path of improvement of security and privacy for the Enterprise Mobility Management Systems, called “dual-persona smartphone” consists of the virtualization of the mobile device and establishment of two independent partitions, one for the business apps and one for the personal apps. Proposed by mobile providers like Samsung™ (Knox), VMware™ (VMware Horizon Mobile), Blackberry™ (BES), Cellrox™ (ThinVisor), Red Bend™ (True), AT&T™ (Toggle) et al., the method provides better privacy for the mobile subscriber, but mostly versus the enterprise IT team.

The improvements in the functionality and performance of the mobile devices allow their users to adopt various roles or “personas” for performing their tasks and to switch between these roles at their will. Systems have been described for implementing this multi-persona concept, for example U.S. Pat. No. 7,086,008 and International Publication WO 2013/128440. In these systems, each persona is defined by a specific set of parameters that are appropriate for performing a certain set of transactions. In the embodiments described U.S. Pat. No. 7,086,008, the specific set of parameters can be extended by or via the applications running on the mobile device. Several methods are described for triggering the switching between personas. The personalization of the advertisings for each persona is given as a typical application example.

Various, systems of the art enable mobile devices applications to access enterprise servers, services and documents, as well as personal and generic/entertainment services provided by various service providers over the Internet (be it wired or wireless). This dual use of mobile devices raises concerns related to the security of the enterprise computer networks and the unauthorized transfer of enterprise confidential data to third parties. The relative complexity of the enterprise mobility ecosystem creates a relatively large (malware) attack surface, covering the mobile devices, the wireless communication networks and the enterprise and service providers' computing networks and applications libraries.

The growing use of commercial-grade mobile devices to store valuable information (enterprise documents and data, identity information—usernames & passwords, security certificates and encryption keys, etc.) and to access confidential enterprise data and enterprise servers, services and networks make them a looked-after target for various types of cyber-attacks, as shown by the soaring number of reported mobile security breaches and the increase of their sophistication level. Also, the use of mobile devices in regulated industries at national and international level (financial, healthcare, e-Government, first responders, military, etc.) raises the need for enforceable and verifiable compliance. Current embodiments use a variety of technologies and methods to facilitate the operation of enterprise mobility ecosystems in order to improve the efficiency of the mobile workforce and to protect the enterprise data, computers and networks. These measures comprise the following main capabilities: MEM—(Mobile Email Management), MDM—(Mobile Device Management), MAM—(Mobile Applications Management) and MCM—(Mobile Content Management), used either independently or in combination. All of these security measures have in common the security protection of the enterprise servers, computing networks, applications, documents and confidential data. On the other hand, these measures typically lack focus and support for a comprehensive security protection of the mobile device itself against cyber-attacks and for the privacy of the mobile subscriber and his/her personal data. The unprotected Internet interface of the personal and generic/entertainment applications residing on the mobile devices represents the main path for perpetration of cyber-attacks against Enterprise Mobility Management Systems. It allows the malware infection of the mobile devices using a variety of deception techniques (rogue applications, rogue URLs, contaminated attachments to email and SMS/MMS messages and video/audio data streams, etc.) and malware payloads (viruses, Trojans, APTs). When the delivered malware content is activated it may be used to exploit security holes to access in stealth mode local devices like GPS, voice recorder and camera, to transfer local confidential and personal data (credentials/passwords, security certificates, documents, contact information, etc.) to the attacker's Command & Control Center, to get full control of the mobile device (rooting) and, finally, to propagate the malware content to the enterprise networks. These threats against the applications in the currently unprotected personal and entertainment domains may directly affect the security of the enterprise domain and represent a major security concern that needs a security solution as strong as that used for the enterprise in-house networks.

A secure-by-design implementation of the enterprise mobility ecosystems is highly desirable for all the stakeholders in that market. There is thus a need in the industry to offer users mobile devices that can access both enterprise data and sensitive personal data securely.

### SUMMARY OF INVENTION

It is an object of the present invention to provide a mobile device with improved security.

It is another object of the present invention to provide a mobile device with improved security for running enterprise applications.

It is a further object of the present invention to provide a mobile device with improved security for running sensitive personal applications.

It is yet another object of the present invention to provide a mobile device with improved security for running, enterprise applications, sensitive personal applications, and generic applications.

It is yet a further object of the present invention to provide a mobile device with improved security for running, enterprise applications, sensitive personal applications, and generic applications each application running on a separate partition.

It is yet another object of the present invention to provide an external cloud computing environment for early detection and prevention of intrusion of malware content from the Internet or mobile Internet to the mobile device.

The present invention thus relates to a security system for operating a mobile device comprising a processor and memory with improved security, the system comprising:

a secure boot software component adapted for verifying via the processor the integrity of the infrastructure software components of the mobile device comprising boot package and then loading them on the mobile device processor;

a partition software component adapted for creating via the processor a mobile operating environment that creates and manages three types of separated partitions that operate applications in the enterprise partition, personal partition and generic partition, such that a user can only access one partition at a time, and data cannot be transferred between partitions directly or indirectly;

a local application database adapted for storing for each partition a list of accepted applications and a plurality of attributes for each application;

an application dispatcher module adapted for managing via the processor the local application database of each partition and controls the addition, removal and operation of all applications and allocates resources and verifies access requests of each application;

a resource virtualization module adapted for managing via the processor access to local resources by providing: (a) virtual internal memory with specific mapping for each application; (b) virtual file system specific to each application; and (c) virtual Input/Output (I/O) drivers for all local I/O resources; and

security policies for each partition to control which applications can be installed in each partition and what resources are accessible for each installed application.

In some embodiments, a Personal/Generic Mobility Management (PGMM) component is located in a multi-tenant personal cloud area for scanning and filtering of the incoming Internet traffic to the applications in the personal and generic partitions of the mobile device and performing the malware detection, prevention and removal for this traffic.

In some embodiments, the mobile device operates a virtualized architecture based upon a Hypervisor type 2 software module (package) adapted for the creation and management of several virtualized independent partitions.

In this case, the virtualized architecture of the mobile device software comprises the following:

(i) an operating system running upon said mobile device bare machine (bare machine designates the mobile device/machine hardware components), wherein said hypervisor type 2 software module runs above said operating system;

(ii) common local support services on the mobile device; and

(iii) a trusted platform module (TPM) package in charge of secure storage and processing of cryptographic material comprising encryption keys and security certificates,

wherein said hypervisor type 2 module runs said three separated partitions: the enterprise partition, the personal partition and the generic partition.

In some embodiments, the common services comprise one or more of the following services: mobile device management (MDM) services, mobile applications management (MAM) services, mobile content management (MCM) services, a mobile applications dispatcher/broker module, baseband application services, firmware-over-the-air (FOTA) wireless communication services, intrusion detection/intrusion prevention services (IDS/IPS), antivirus services and encryption/decryption services for the traffic over the wireless communication channels and for the locally stored sensitive data,

wherein, the MDM, MAM and MCM services (software clients/modules) manage, control and monitor the implementation of various security policies and the mobile applications dispatcher/broker module manages, controls and monitors the operation of the mobile applications over their entire lifetime (downloading, activation, operation and removal).

In some embodiments, the mobile device operates a virtualized architecture based upon a Hypervisor type 1 software module adapted for the creation and management of several virtualized independent partitions.

In this case, the virtualized architecture of the mobile device software comprises the following:

(i) the Hypervisor type 1 software module running on the mobile device bare machine, adapted for creating and managing the three separated partitions: the enterprise partition, the personal partition and the generic partition, each of said separate partitions running its own operating system;

(ii) common local support services on the mobile device; and

(iii) a trusted platform module (TPM) package in charge of secure storage and processing of cryptographic material comprising encryption keys and security certificates.

In some embodiments, the common services comprise one or more of the following services: mobile device management (MDM) services, mobile applications management (MAM) services, mobile content management (MCM) services, a mobile applications dispatcher/broker module, baseband application services, firmware-over-the-air (FOTA) wireless communication services, intrusion detection/intrusion prevention services (IDS/IPS), antivirus services and encryption/decryption services for the traffic over the wireless communication channels and for the locally stored sensitive data,

wherein, the MDM, MAM and MCM services (software clients/modules) manage, control and monitor the implementation of various security policies and the mobile applications dispatcher/broker module manages, controls and monitors the operation of the mobile applications over their entire lifetime (downloading, activation, operation and removal).

In both types of embodiments (Hypervisor types 1 and 2), the virtual partitions environment running on the mobile device precludes the transfer of data between the applications running in any virtual partition and the operating system partition.

In both types of embodiments (Hypervisor types 1 and 2), the virtual partitions environment running on the mobile device precludes the transfer of data between applications residing in different virtual partitions. As the applications are operated in closed containers, data transfers are allowed between applications residing in the same partition (container).

In some embodiments, the data transfers between an application residing in a closed partition (container) and applications/entities (for example a cloud) operated outside the partition (container) are allowed only if these operations are explicitly defined for the application residing in the closed container.

In both types of embodiments (Hypervisor types 1 and 2), the MDM, MAM and MCM services, as well as the application dispatcher/broker module operating in the enterprise partition are controlled, managed and monitored by enterprise resources outside the mobile device and according with the enterprise security policies.

In both types of embodiments (Hypervisor types 1 and 2), the MDM, MAM and MCM services, as well as the application dispatcher/broker module in the personal and generic/entertainment partitions can be controlled, managed and monitored by a dashboard personal application management package residing in the mobile device.

In some embodiments, the mobile device is a telephone, a smartphone, a tablet computer, a laptop computer, a Personal Digital Assistant (PDA) or a portable gaming console or any similar mobile device.

### BRIEF DESCRIPTION OF DRAWINGS

FIG. 1 is a block diagram of an embodiment of a mobile telephone with the security system of the invention operating three distinct partitions: enterprise (work), personal and general/play.

FIG. 2 is a block diagram of an embodiment of the mechanism for the virtualization of the mobile device software package using a type 2 hypervisor.

FIG. 3 is a block diagram of an embodiment of the mechanism for the virtualization of the mobile device software package using a type 1 hypervisor.

FIG. 4 is a flowchart of a method for the activation of the virtualized mobile device software package using a type 2 hypervisor.

FIG. 5 is a flowchart of a method for the activation of the virtualized mobile device software package using a type 1 hypervisor.

FIG. 6a is a schematic block diagram of the current interconnection of the mobile devices to their Service Providers via their Cellular Service Provider.

FIG. 6b is a schematic block diagram of the secure interconnection of the personal and generic/entertainment applications on the mobile device to the Internet channel via a Personal/Generic Mobility Management (PGMM) component located in a multi-tenant personal cloud area.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” means any one or more microprocessors, central processing units (CPUs), computing devices, microcontrollers, digital signal processors, or like devices.

The present invention relates to a security system for operating a mobile device with improved security. The term “mobile device” as used herein includes a telephone, a smartphone, a tablet computer, a laptop computer, Personal Digital Assistant (PDA), a portable gaming console and any other similar existing or future device. The mobile device typically comprises a processor (one or more), memory, one or more input units (keyboard, keypad, mouse, touch screen, pointing device, voice recognition etc.), a display and one or more wireless communication protocols (Internet connectivity, wide area networks, cellular data access, Bluetooth, NFC etc.).

The security system of the invention comprises a secure boot software component adapted for verifying the integrity of the infrastructure software components of the mobile device comprising boot package and operating system and then loading them on the mobile device processor.

The security system of the invention also comprises a partition software component (for example, hypervisor type 1 or type 2) adapted for creating a virtualized mobile operating environment that creates and manages three separated partitions: an enterprise partition, a personal partition and a generic partition, such that a user can only access the applications and data of one partition at a time, and data cannot be transferred between partitions directly or indirectly.

The security system of the invention further comprises a local application database adapted for storing for each partition a list of accepted applications and a plurality of attributes for each application.

An application dispatcher/broker module of the invention is adapted for managing the local application database of each partition. The application dispatcher thus controls the addition, monitoring, operation and removal of all applications (in each partition) and allocates resources and verifies access requests of each application.

The security system of the invention further comprises a resource virtualization module adapted for managing access to local resources by providing: (a) virtual internal memory with specific mapping for each application; (b) virtual file system specific to each application; and (c) virtual Input/Output (I/O) drivers for all local I/O resources.

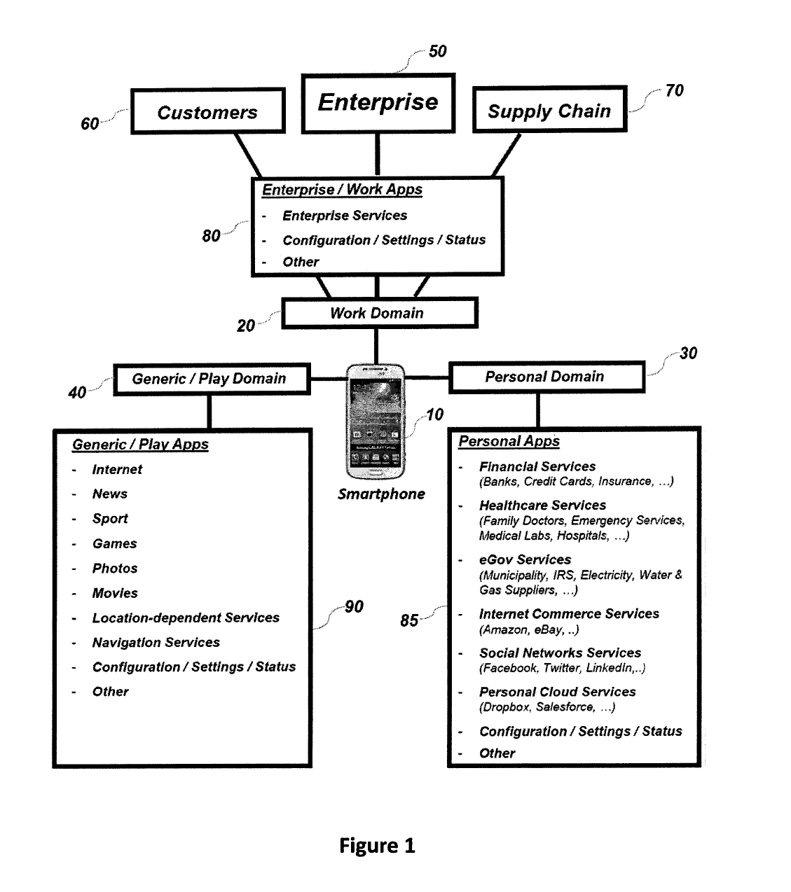

Reference is now made to FIG. 1 showing an embodiment of a mobile phone 10 of the invention comprising three partitions: an enterprise partition 20, a personal partition 30 and a generic partition 40.

A mobile subscriber can operate work-related applications on a mobile device 10 in order to securely and efficiently access his enterprise 50 (application servers, networks, services, documents and databases) for performing work-related tasks while on-the-move. The business/work-related applications 80 are grouped in a separate enterprise/work partition/domain 20 that is precluded from directly or indirectly communicating with other partitions/domains in the mobile device in order to minimize the probability of loss of enterprise data and the propagation of malware within the mobile device and towards the enterprise servers and networks. The transfer of data from the work partition to other partitions directly by an application or indirectly using various methods such as cut-and-paste operations and storage in an external cloud environment is precluded and kept consistent with the enterprise security policy. Whenever required, the work-related applications 80 may also communicate and exchange data with customers 60 and with companies/entities in the Supply Chain 70, either directly or via the enterprise servers and services. The typical set of work-related applications 80 comprises contacts, schedule, email, instant messaging, notes, team cooperation tools, direct access to the enterprise telephony network, video conferencing, access to line-of-business documents and databases, etc.

A mobile device 10 configuration and settings control application allows the local and remote provisioning, management, control and monitoring of the mobile device 10 resources allocated to the work partition 20. The mobile device 10 gets access to the enterprise 50 services and data only after a successful mutual authentication process is completed between the mobile device 10 and the centralized enterprise mobility management servers of the enterprise 50. The authentication process also verifies that the mobile device 10 is not compromised/rooted (no malware application illegally gained system access privileges known as “root access” in some systems) or jail broken and is not declared as lost or stolen. After the successful establishment of the session between the mobile device 10 and the enterprise 50 back-end servers, the applications 80 operated by the mobile subscriber get access to specific enterprise 50 networks, servers, services and data according with the access rights defined for each subscriber (role-based) in the enterprise security policy matrix. The operation of specific enterprise applications 80 may require the authentication of the identity of the mobile subscriber using an application-specific username and password or an equivalent procedure using any combination of authentication procedures of the art (biometric procedures, using personal cards or personal hardware devices, reviewing location-based parameters etc.).

The enterprise/work partition/domain 20 of the invention offers an enterprise mobility ecosystem that promotes enhanced security for the enterprise 50 data/IP (intellectual property) and improved privacy protection for the mobile subscribers. The enterprise servers, working with the mobile device 10, comprise a centralized enterprise mobility management module which includes at least the following set of main functions: Mobile subscriber and mobile device enrollment, provisioning and decommissioning; Remote control & monitoring of the mobile device configuration (hardware, software & applications); Management of enterprise security policy matrix; Mobility Management Application Console/Dashboard; Mobile applications downloading from enterprise's applications library; Authentication of mobile subscriber sessions and access to enterprise back-end applications, data and services; Recovery services for lost, stolen or compromised mobile devices, such as remote wipe (deletion) of the applications and data in the mobile enterprise partition, device location report/display, remote phone call, etc., in case the mobile device is lost, stolen, compromised/rooted or jail broken; and Remote mobile applications performance management.

In principle, the invention allows also for mobile device access from the work partition to multiple enterprises whenever the mobile subscriber works for multiple companies/entities such is the case for contractors, doctors and other professionals or when the mobile subscriber needs direct wireless access to his/her enterprise's Customers and Suppliers.

The mobile subscriber can also access sensitive personal-related applications on the mobile device 10 located in a separate personal partition 30. The personal partition 30 typically includes personal-related 85 applications offered by service providers usually operating in regulated industries (financial, healthcare, e-Government, etc.), wherein these applications access sensitive, and private user data that needs to remain confidential. The personal-related applications 85 in the partition 30 are precluded from directly or indirectly communicating with other partitions (20, 40) in order to minimize the probability of breach of privacy and/or loss of personal data and the propagation of malware within the mobile device 10 and towards the service providers' servers and networks. The transfer of data from the personal partition 30 to other partitions (20, 40), either directly by an application or indirectly using various methods such as cut-and-paste operations and storage in an external cloud environment, are precluded and kept consistent with the security policies set-up by the mobile subscriber. The applications 85 operating in the personal partition 30 can be provided by and downloaded from the service provider internet site. Alternatively, the applications 85 (some or all) can be preloaded on the mobile device 10. These applications 85 are usually operated in secure (closed) containers that ensure the protection of the information exchanged between the mobile device 10 and the service provider servers and preclude the transfer of private information to external entities including other applications running in the same personal partition 30. A mobile device 10 configuration and settings control application under mobile subscriber control allows the provisioning, management, control and monitoring of the local device 10 resources allocated to the personal partition 30. The mobile devices 10 get access to the services and data provided by the service provider only after a successful mutual authentication process is completed between the mobile device 10 and the servers of the service provider. The authentication process may also verify that the mobile device 10 is not compromised/rooted or jail broken and is not declared as lost or stolen. After the successful establishment of the session between the mobile device 10 and the service provider back-end servers, the applications 85 operated by the mobile subscriber get access to specific service provider networks, servers, services and data according with the access rights defined for each subscriber in the service provider security policy matrix. The operation of additional service provider applications may require the authentication of the identity of the mobile subscriber using an application-specific username and password or an equivalent procedure with combination of authentication procedures of the art (as described above).

The mobile subscriber can also operate generic applications 90 on its mobile device 10 for accessing news, games, multimedia (pictures, photos, video clips and movies), location-dependent and navigation services, etc. The generic applications 90 are grouped in a separate generic/play partition/domain 40 and after acquisition and download, can be operated by the mobile subscriber without the need to enter a username and a password. A careful mobile subscriber will load generic applications 90 from well-known providers (Apps Stores) that can be held responsible and liable for the integrity of their applications. But the huge number of generic applications 90, some of them downloadable at a very low cost or free-of-charge, the high costs related to the verification (malware-free) of new applications and the sophistication of the mobile devices 10 attacks generates a non-zero probability that rogue applications, rogue web sites and other means of carrying malware can propagate various type of malware to the mobile devices 10, especially in the generic/play partition 40. The capability of this embodiment to preclude the transfer of data and, implicitly the malware, between the partitions 20, 30, 40 of the mobile device 10 and to its infrastructure/operating system contributes to the preservation of the integrity and sanity of the mobile device 10 software and data.

At any time, only one virtualization partition 20, 30 or 40 can be active for mobile user interaction. At any time, the mobile user can switch between applications belonging to the same or different partitions. Incoming phone calls and alert messages such as incoming calls, SMS messages, or system warnings are presented to the mobile user in whatever partition is active at that given time.

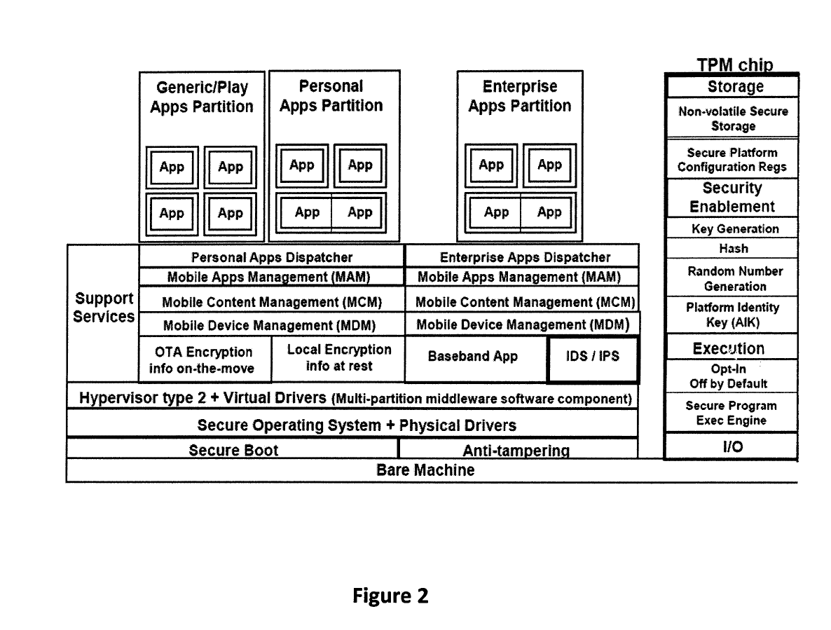

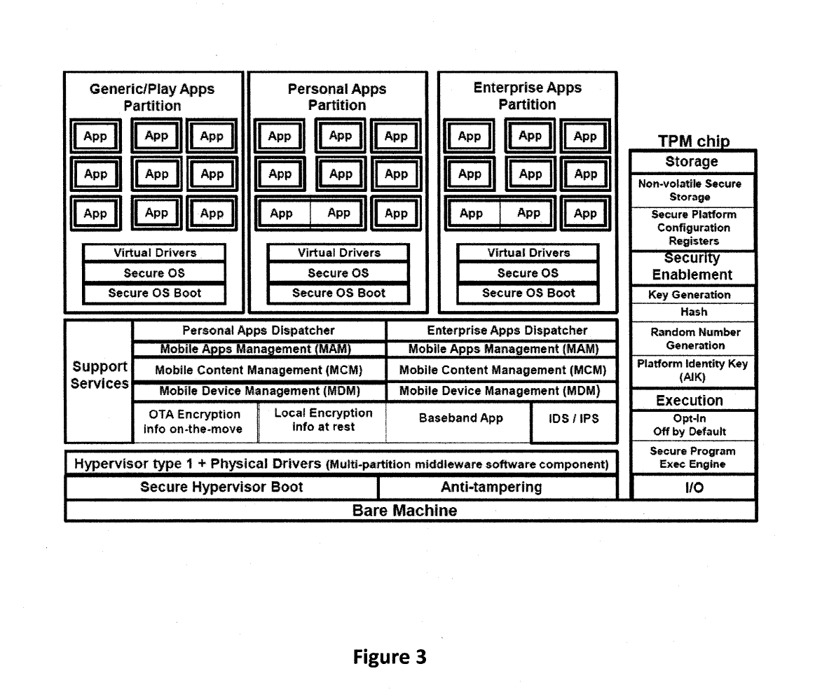

FIG. 2 and FIG. 3 illustrate in more detail embodiments of a system and method for protecting mobile devices 10 against malware attacks by separation of the business 20, personal 30 and generic 40 partitions, each partition hosting its own applications and data. By way of example, these embodiments are based on a suitable hardware virtualization technique called virtual machine manager (VMM) or “hypervisor” (though a person skilled in the art would know to implement the same principles with other existing or future technologies). The hypervisor is a supervisory software package that creates an abstraction layer between the platform hardware and the operating systems (or between the operating system and the mobile applications) and serves as an underlying technology for computer virtualization. It allows for multiple operating systems to concurrently run on a host computing platform that provides a separate virtual operating partition to each one of the guest operating systems and manages their execution, including their specific set of applications. At this point of time, three main types of hypervisors are known to the art, called “hypervisor type 0”, “hypervisor type 1” and “hypervisor type 2”.

The hypervisor type 0 runs directly over the platform hardware and has a lightweight architecture designed specifically for embedded systems. It doesn't need a supporting operating system and provides a toolset for granular control over system resources that reduces the system attack surface and achieves high-reliability for mission-critical environments. It also leverages the features of the 3rd generation Intel Core™ processors supporting Intel Virtualization Technology (Intel VT™). An example of type 0 hypervisor is “Linux Secure™” from LynuxWorks™ (of 855 Embedded Way, San José, Calif. 95138-1018, USA).

The hypervisor type 1 (also called native or bare metal hypervisor) runs directly over the platform hardware, controls the system hardware components and manages the guest operating systems, running above the hypervisor level. Typical examples of type 1 hypervisors include VMware ESXi, Microsoft Hyper-V, Open Kernel Labs/General Dynamics OKL4 Microvisor and Citrix XenServer.

The hypervisor type 2 (also called hosted hypervisor) runs within/above a standard operating system (Linux™, Android™) as a separate software layer with the guest virtual operating partitions operating above the hypervisor level. Typical examples of type 2 hypervisors include open source software KVM (for Kernel-based Virtual Machine) and Oracle™'s VirtualBox (Oracle Corporation, 500 Oracle Parkway, Redwood Shores, Calif. 94065, USA).

FIG. 2 discloses a generic configuration for mobile devices 10 based on a hypervisor type 2 that is intended to cover mobile devices 10 with limited internal resources (smartphones and low-end tablets).

The mobile device 10 basic hardware is marked as “Bare Machine”. On top of the Base Machine runs a Secure Boot of the invention with specific anti-tampering technology that verifies that no malicious application has taken control of the boot sector (and thus having access to sensitive resources of the operating system). The Secure Boot loads the Operating System along with the physical drivers.

The operating system then launches the partition software component adapted for creating a virtualized mobile operating environment that creates and manages multiple types of separated partitions, in this embodiment the Hypervisor type 2 software component along with the virtual drivers.

The partition software comprises a local application database adapted for storing for each partition a list of accepted applications and a plurality of attributes for each application. The application attributes can include: name, publisher, version, date of installation, permission attributes regarding local (memory, I/O devices, etc.) and external (web sites, computing and storage clouds, collaboration partners, etc.) resources the application can connect with, permission attributes regarding actions the application can perform etc.

The partition software comprises an application dispatcher/broker module adapted for managing the local application database of each partition that controls the addition, operation, monitoring and removal of all applications and allocates resources and verifies access requests generated by each application. There can be one application dispatcher that manages all applications for all partitions (or more than one partition) or there can be individual instances of an application dispatcher for a single partition.

In the embodiment shown in FIG. 2, there is shown an application dispatcher for the Work (enterprise) partition 20 and another application dispatcher for both the personal 30 and general 40 partitions. The Application Dispatcher for the Work partition 20 allows the Enterprise IT personnel to remotely download, manage, control, monitor and wipe/inactivate the applications in this partition 20 from a centrally located Dashboard Mobility Management Module. The Application Dispatcher for the Personal Partitions 30 allows the mobile subscriber to perform the same functions related to the applications in this partition 30 from a local module called Local Dashboard Mobility Management Module. The Application Dispatcher (be it Work or Personal) works in conjunction with the Mobile Applications Management (MAM) module, the Mobile Content Management (MCM) module and the Mobile Device Management (MDM) module.

The Work and Personal Application Dispatchers also provide access to local data encryption/decryption services, such as Over-the-Air (OTA)/Wireless Communication Channels Encryption and Local Files Encryption.

The Work and Personal Application Dispatchers also provide to the applications they serve access to the baseband wireless communication services and IDS/IPS (Intrusion Detection/Prevention System) services.

FIG. 3 discloses a generic configuration for mobile devices 10 based on a hypervisor type 1 (& type 0) that is intended to cover mobile devices 10 with ampler internal resources (high-end smartphones and tablets, laptops and computers embedded in mobile platforms).

The mobile devices 10 operate on a hardware computing platform (bare machine) consisting of a System-on-a-Chip (SoC) computing element, a display unit, several wireless communication engines (3G/4G LTE/HPSA+, WiFi, Bluetooth), peripheral devices (GPU—graphics processing units/accelerators, external memory, video cameras, position/acceleration/compass sensors, GPS receiver, etc.) and power supply and wired (local) communication interfaces.

The SoC usually contains general purpose and graphical microprocessors connected to internal memory banks and to peripheral interfaces, with some of the processors potentially using a multi-core architecture.

One of the embedded processors is the Trusted Platform Module (TPM) that is used for the secure storage/depository of the cryptographic material (security certificates and encryption keys) and the platform configuration registers, for generation of the random numbers and the dynamic encryption keys used in the cryptographic algorithms and for support of the encryption/decryption operations of the sensitive content, stored locally or transferred over the wireless communication channels.

The mobile device 10 uses a secure boot software procedure that verifies the integrity of the infrastructure software components (boot package, hypervisors, operating systems and other middleware software) and loads them on the mobile device 10 microprocessors. In the case of simpler mobile devices 10 (see FIG. 2), the secure boot loads and activates the operating system and, then, the hypervisor type 2 that contains a multi-partition middleware software component responsible for generating, managing and control of a virtualized environment containing several separated partitions, each one with its own non-overlapping memory space. In the case of more complex mobile devices 10 (see FIG. 3), the secure boot activates the hypervisor type 1 that operates a multi-partition middleware software component responsible for generating, managing and control of a virtualized environment containing several separated partitions, each one with its own operating system and a non-overlapping memory space. Optionally, for additional mobile device 10 security, an anti-tampering procedure sets a “compromised device” flag whenever detects undesired modifications in the software infrastructure packages or when the device 10 is open and its software and/or hardware are potentially altered.

The Enterprise Applications Partition 20 runs the enterprise's provided applications 80. The Personal Applications Partition 30 runs the personal applications 85 provided by the service providers and as selected by the mobile subscriber. These applications usually operate in applications containers that protect the security and privacy of the personal data. Each applications container (partition) operates one or more applications from the same service provider, uses its own private memory space and usually encrypts all the personal content (if any) in the mobile device's 10 external memory as required in the regulated domains (financial, healthcare, eGovernment, etc.). The Generic/Play Applications Partition 40 runs generic/entertainment applications 90 typically downloaded from public libraries and locations.

Common support services may be operated in the context of the local hypervisor or as a separate partition with its own secure operating system. Common support services comprise baseband software packages, intrusion detection/intrusion prevention (IDS/IPS) and antivirus software packages, encryption/decryption management of the sensitive local information (at-rest), encryption/decryption management of the information transmitted over the wireless channels (over-the-air—OTA), the mobile device 10 management client software packages, the application dispatcher/broker module and the physical drivers software package.

The multi-partition middleware software component manages a virtualized mobile operating environment that improves the mobile device 10 security and the privacy of the locally stored data. It creates and manages three types of separated partitions 20, 30 and 40 that operate applications in the enterprise (work) 20, personal 30 and generic 40 partitions, while precluding the inter-partition transfer of data (and malware). The middleware software component of the invention is primarily intended for implementation and integration in the Android™ operating system environment (open source). The middleware software component can be also adapted to operate in other mobile operating system environments, like Blackberry™ BB10, Microsoft Widows8™, Apple™ iOS, etc.

The virtualized enterprise partition 20 on the mobile device 10 runs work-related apps 80 that interact with the enterprise 50 networks and servers and use the enterprise 50 services and data, the latter of a proprietary and confidential nature. The mobile device's applications 80 establish an active session with the enterprise's 80 mobility management server only after the mobile subscriber enters a correct username and password (and/or any other authentication input) and a successful mutual authentication process is completed between the mobile device 10 and the enterprise 50 servers. The authentication process also verifies that the mobile device 10 is not compromised/rooted or jail broken and is not declared as lost or stolen (and, as such, allowing undesired access to confidential or personal information). An application is considered “rooted” when a user attains a privileged control know on some systems (ANDROID, UNIX, etc.) as “root access”, giving him access to sensitive operating system data and to perform sensitive operating system operations. Jail breaking is the process of removing the limitations on an operating system, such as Apple™ Inc. iOS, that is a form of privilege escalation, through the use of software and hardware exploits that permits root access to the operating system and allows the download of applications, extensions, and themes that are unavailable through the official channels (such as Apple™ App Store).

After the successful establishment of the session between the mobile device 10 and the enterprise 50 mobility management server, the applications 80 operated by the mobile subscriber get access to specific service provider networks, servers, services and data according with the access rights defined for the mobile subscriber in the enterprise 50 security policy matrix. The operation of specific enterprise applications 80 may require the authentication of the identity of the mobile subscriber using an application-specific username and password or any equivalent authentication procedure. The middleware software component in the mobile device 10 improves the security of the content (applications code and data) of the enterprise partition 20 by precluding direct and indirect transfer of data (and malware) from the generic 40 and personal 30 partitions to the enterprise partition 20 (and vice versa) and from there to the enterprise 50 back-end. This level of data protection is in addition to any other security measures implemented in the mobile device 10: “freezing” of the access to the enterprise partition 20 whenever the mobile device 10 is detected as compromised/rooted of jail broken or declared as lost or stolen; remote wipe/deletion of the applications and data in the enterprise partition 20 if one of the previous events occur; “opening” of the work in enterprise partition 20 only after the validation of the mobile subscriber identity (username and password and/or any other authentication requirement); operation of validated applications in the enterprise partition 20, downloaded from the enterprise applications 80 library only; local encryption of the enterprise data; mutual authentication between the mobile subscriber/device 10 and the enterprise applications 80 servers; encryption of the communication channel between the mobile device 10 and the enterprise 50. The cryptographic material (encryption keys and security certificates) used in the enterprise partition 20 is securely stored and processed in the local TPM (Trusted Platform Module).

The virtualized personal partition 30 on the mobile device 10 runs personal applications 85 that interact with personal service provider networks and servers and use their services and data, the latter proprietary and confidential to the mobile subscriber. The mobile device applications 85 establish an active session with a specific service provider only after the mobile subscriber enters a correct username and password (and/or any other authentication requirement) and a successful mutual authentication process is completed between the mobile device 10 and the service provider servers. The authentication process also verifies that the mobile device 10 is not compromised/rooted or jail broken and is not declared as lost or stolen. After the successful establishment of the session between the mobile device 10 and the service provider, the applications 85 operated by the mobile subscriber get access to specific service provider networks, servers, services and data according with the access rights defined for each subscriber in the service provider security policy matrix. The operation of specific service provider applications may require the authentication of the identity of the mobile subscriber using an application-specific username and password or an equivalent procedure. The middleware software component in the mobile device 10 improves the security of the content (applications code and data) of the personal partition 30 and the privacy of the mobile subscriber personal data by precluding direct and indirect transfer of data (and malware) from the generic 40 and enterprise 20 partitions to the personal 30 partition and vice versa and includes the denial of inter-partitions cut & paste operations. This level of data protection is in addition to other security measures implemented in the mobile device 10: “freezing” of the access to the enterprise partition 20 whenever the mobile device 10 is detected as compromised/rooted of jail broken or declared as lost or stolen; remote wipe/deletion of the applications and data in the personal partition 30 if one of the previous events occur; “opening” of the work in personal partition 30 only after the validation of the mobile subscriber identity (username and password and/or any other authentication requirement); operation of validated applications in the personal partition 30, downloaded from the personal service provider applications library only; local encryption of the enterprise 50 data. The cryptographic material (encryption keys and security certificates) used in the personal partition 30 are securely stored and processed in the local TPM (Trusted Platform Module). In order to provide additional protection to the applications code and data in the personal partitions 30 (against each other), they will be operated in closed containers that preclude the transfer of data (and malware) between applications. The proliferation of the number of applications that are operated in the personal partition affects the user experience due to the need to remember a large number of different complex usernames and passwords. This drawback can be mitigated by using a single sign-on (SSO) mechanism that use an initial multiple-factor authentication procedure (using username, password and a biometric device and/or a security token) and automatically derives subsequent username+password pairs from a preprogrammed depository securely stored in the TPM.

The virtualized generic partition 40 on the mobile device 10 runs generic (entertainment, games, navigation and location-dependent, internet and other) applications 90 that interact with content service provider networks and servers without the need of subscriber authentication. These interactions may include rogue applications and rogue internet web sites aimed to steal mobile data and to inject malware into the mobile ecosystem. The middleware software component in the mobile device 10 improves the security of the content (application code and data) of the personal 30 and enterprise 20 partitions and the privacy of the mobile subscriber personal data by precluding direct and indirect transfer of data (and malware) from the generic partition 40 to the operating system infrastructure and the enterprise 20 and personal 30 partitions and vice versa and includes the denial of inter-partitions cut & paste operations. This level of data protection is additional to the other potential security measures implemented in the mobile device like the universal app-scanning system introduced by Google™ in Android v4.3.

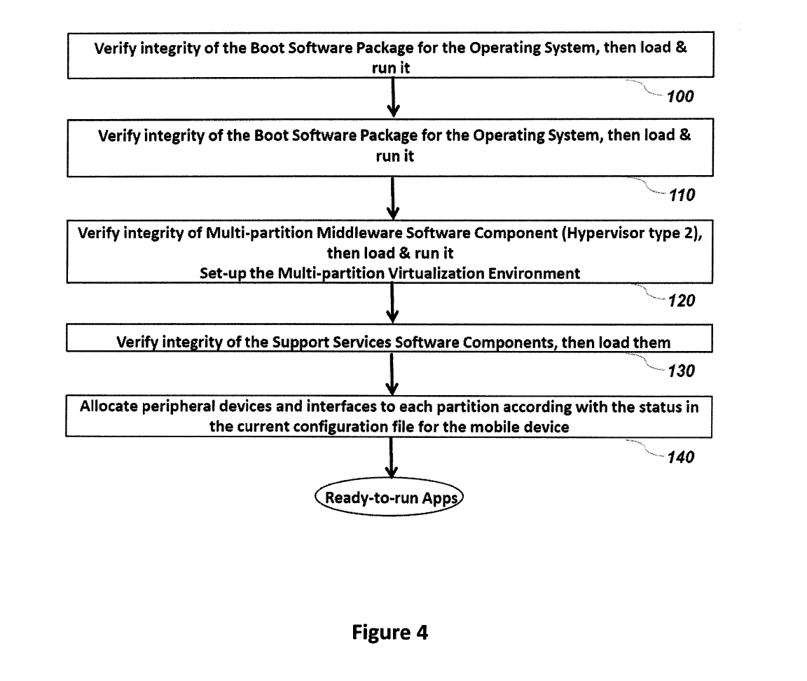

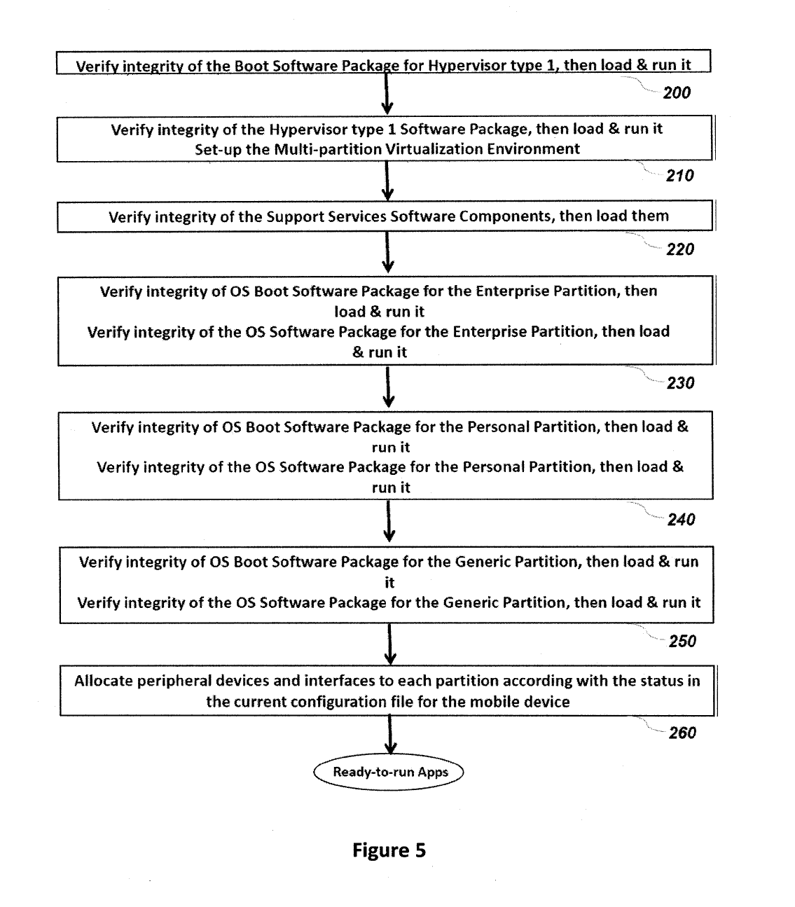

The security procedures and methods described above are enforceable only if the software infrastructure installed in the mobile device 10 is secure and trustable. The flowcharts in FIGS. 4 and 5 illustrate examples of procedures of integrity check and activation of the software infrastructure in the mobile device 10 for the configurations based on hypervisor type 2 and type 1, respectively. The procedures are consistent with the similar process implemented in most current mobile devices 10.

For the hypervisor 2 configuration (FIG. 4) in step 100 the procedure starts at power-up with the verification of the integrity of the Boot Software Package for the Operating System. If successful, it is loaded and set-to-work. Then, in step 110 the Boot Software Package verifies the integrity of the Operating System (including the physical drivers) and, if successful, loads and runs it. In step 120 the Operating System verifies the integrity of the Multi-Partition Middleware Software Package (Hypervisor type 2) and, if successful, it is loaded and set to run. The Multi-partition Middleware Software Package builds-up the virtualized multi-partition environment and in step 130 verifies and loads the Support Services Software Components/Packages (Baseband, Encryption and Mobile Device Management Client, etc.). In step 140 it also allocates to each partition the peripheral devices and interfaces according with the current configuration file. Then, the mobile device 10 becomes ready to run applications in anyone of the operational partitions.

For the hypervisor 1 configuration (FIG. 5) in step 200 the procedure starts at power-up with the verification of the Hypervisor Boot Software Package and, if successful, the Hypervisor Boot Software Package is loaded and run. Afterwards in step 210 the Hypervisor Boot Software Package checks the integrity of the type 1 Hypervisor Software Package and, if successful, loads and runs it. The type 1 Hypervisor builds-up the virtualized multi-partition environment. In step 220 the type 1 Hypervisor verifies the integrity of the Support Services Software Components/Packages and, if successful, loads and runs them.

Then, in step 230 the type 1 Hypervisor prepares for operation the Operating System for the Enterprise/Work partition. The integrity of the Boot Software Package for the Operating System of the Enterprise/Work 20 Partition is verified and, if successful, is loaded and set-to-run. The Boot Software Package verifies the integrity of the Operating System for the Work 20 Applications Partition and, if successful, loads and runs the Operating System for the Work Applications 30 Partition. Then, in step 240 the type 1 Hypervisor performs the same for the Personal Applications Partition 30, i.e. checks the integrity of the Boot Software Package for the Operating System of the Personal Applications Partition 30 and, if successful, loads and runs it. Then, the Boot Software Package checks the integrity of the Operating System for the Personal Apps Partition and, if successful, loads and runs the Operating System for the Personal Apps Partition 240. In step 250 the type 1 Hypervisor performs the same for the Generic Applications Partition 40, i.e. verifies the integrity of the Boot Software Package for the Operating System of the Generic Applications Partition 40 and, if successful, loads and runs it. Then, the Boot Software Package verifies the integrity of the Operating System for the Generic Apps Partition and, if successful, loads and runs the Operating System for the Generic Apps Partition 40. Finally, in step 260 the peripheral devices and the interfaces are allocated to each partition according with their status in the currently active version of the configuration file for the mobile device 10. Then, the mobile device 10 is deemed ready to run applications in anyone of the operational partitions 20, 30 or 40.

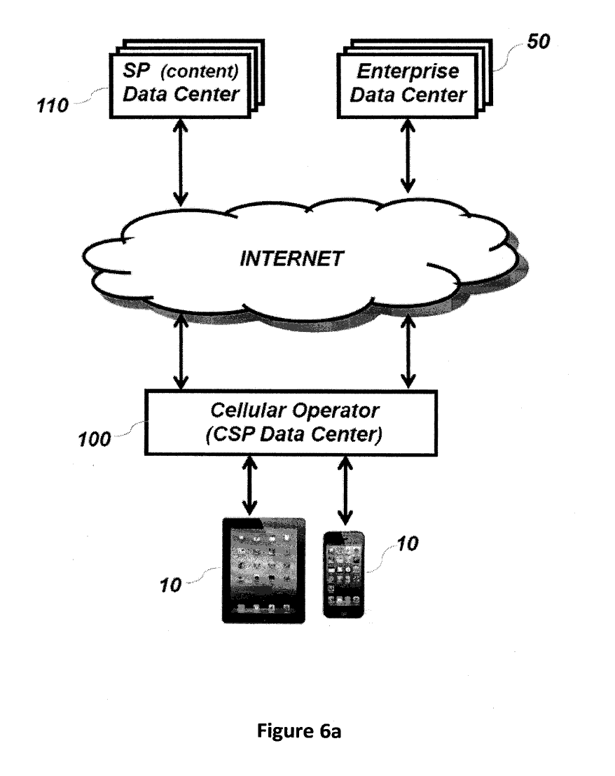

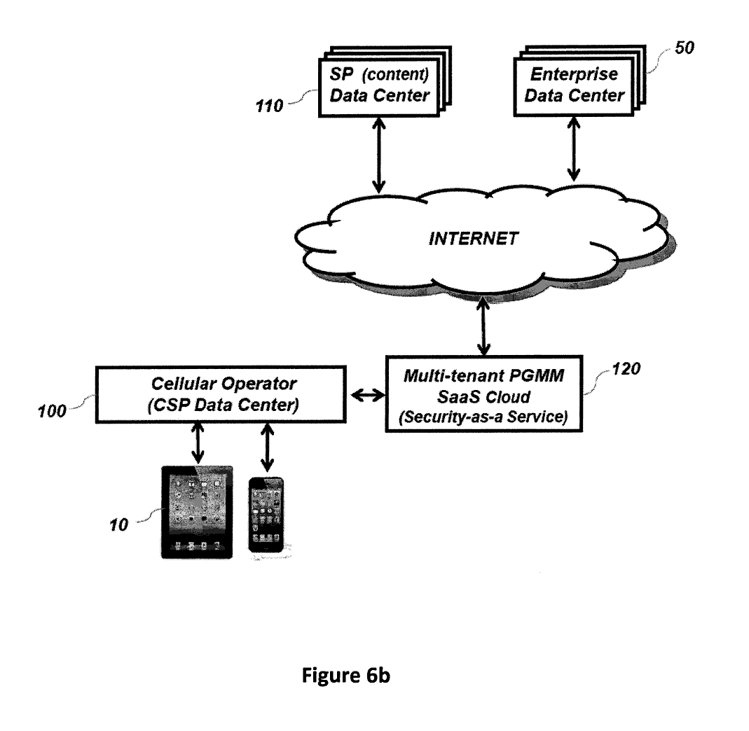

The general diagram for the actual status in the Mobile Wireless Landscape is schematically shown in FIG. 6a. The mobile devices 10 are connected via the wireless cellular network to their Cellular Service Provider (CSP) Data Center 100 that verifies their identity and allocates resources for providing the subscribed services and for billing purposes. Whenever the mobile device 10 is located outside the coverage of its CSP 100, it may access a foreign CSP 100 that has a mutual support roaming agreement with its CSP 100. In this case, the mobile device 10 subscribed service are transparently provided by the foreign CSP 100, sometimes with a slighter higher delay due to the identity validation and billing-related services performed by the foreign CSP 100. Often, the mobile device 10 can access wireless services via a Wi-Fi Access Point located in its vicinity that relays the mobile device service requests either to its CSP 100 or, directly, to an Internet Service Provider (Internet SP) 110. The interconnections for the latter two cases are not shown in FIG. 6a for sake of clarity. The telephone calls within the CSP 100 network are performed using its own resources located in the CSP 100 core network. The CSP 100 core network also provides the audio and control interfaces to perform telephone calls from/to subscribers connected to external cellular or land-based telephony networks. The CSP 100 core network also provides the digital interfaces to the Internet that allow the mobile subscriber to access a multitude of digital services provided by Internet Service Providers (ISPs), Cloud Service Providers (Cloud SPs) and Content Service Providers (Content SPs) 110. The mobile device connection to a Service Provider (SP) network that provides services in a regulated industry (finance, healthcare, etc.) usually requires the verification of the mobile user identity (name/ID and password) and the encryption of the data traffic. The mobile device 10 connection to other Service Provider (SP) networks usually do not require the verification of the mobile user identity (name/ID and password) or the encryption of the data traffic, except the cases when a payment is required for the requested service. The same CSP 100 digital interfaces to the Internet are used to connect the mobile device 10 to the Computer Center of its Enterprise 50, usually using an encrypted link (VPN—Virtual Private Network).

In some embodiments, one or more secure communication channels are established from the personal 30 and generic 40 partitions to a Personal/Generic Mobility Management (PGMM) 120 component located in a multi-tenant personal cloud area, i.e. Security-as-a-Service—SaaS component (see FIG. 6b). The PGMM 120 ensures early detection, report and mitigation of external security, privacy and regulatory compliance threats and enforces the Personal Security Policy for the outbound Internet traffic. The PGMM 120 controls the introduction of any new application installed in the personal 30 or generic 40 partitions, and verifies initially if the application behaves as expected. For example, the application can be initially and for a predetermined amount of time, run from within the personal cloud (and not the mobile device! 10) and all its resource requests and utilization and all its outgoing communication are examined closely. Only after the application shows that behaves as expected it is then transferred to reside on the mobile device 10. Implementing the PGMM 120 in the mobile device 10 is currently not realistic because it would require extensive processing power which would deplete the battery of the mobile device 10. Hence, it makes more sense today to implement the PGMM 120 in a personal cloud area. The multi-tenant personal cloud may also be used for the improvement of the mobile user experience, for example for speeding-up the access to preferred web sites using a web proxy server, for providing encrypted personal email and document depository services, for providing single sign-on (SSO) services that remove the need to remember multiple complex passwords, for providing more secure e-commerce services without the need to keep confidential data on the mobile device, for providing higher quality audio and video-conference services, for providing remote location, wiping and disabling of lost or stolen devices and others.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A security system for operating a mobile device comprising a processor and memory with improved security, the system comprising:
(i) a secure boot software component adapted for verifying via the processor the integrity of the infrastructure software components of the mobile device comprising boot package and then loading them on the mobile device processor;
(ii) a partition software module adapted for creating via the processor a virtualized mobile operating environment that creates and manages three separated partitions: an enterprise partition, a personal partition and a generic partition, such that a user can only access one partition at a time, and data cannot be transferred between partitions directly or indirectly;
(iii) a local application database adapted for storing for each partition a list of accepted applications and a plurality of attributes for each application;
(iv) an application dispatcher module adapted for managing via the processor the local application database of each partition and controls the addition, operation, monitoring and removal of all applications and allocates resources and verifies access requests of each application; and
(v) a resource virtualization module adapted for managing via the processor access to local resources by providing: (a) virtual internal memory with specific mapping for each application; (b) virtual file system specific to each application; and (c) virtual Input/Output (I/O) drivers for all local I/O resources;
(vi) security policies for each partition to control which applications can be installed in each partition and what resources are accessible for each installed application; and
(vii) security policies for each partition to control which applications can be installed in each partition and what resources are accessible for each installed application.

2. The security system according to claim 1, wherein said mobile device operates a virtualized architecture and said partition software module is a Hypervisor type 2 software module adapted for the creation and management of several virtualized independent partitions.

3. The security system according to claim 2, wherein said virtualized architecture comprises:
(i) an operating system running upon said mobile device bare machine, wherein said hypervisor type 2 software module runs above said operating system;
(ii) common local support services on the mobile device; and
(iii) a trusted platform module (TPM) package in charge of secure storage and processing of cryptographic material comprising encryption keys and security certificates,
wherein said hypervisor type 2 module runs said three separated partitions: the enterprise partition, the personal partition and the generic partition.

4. The security system according claim 2, wherein said common services comprise one or more of the following services: mobile device management (MDM) services, mobile applications management (MAM) services, mobile content management (MCM) services, a mobile applications dispatcher module, baseband application services, firmware-over-the-air (FOTA) wireless communication services, intrusion detection/intrusion prevention services (IDS/IPS), antivirus services and encryption/decryption services for the traffic over the wireless communication channels and for the locally stored sensitive data.

5. The security system according to claim 1, wherein said mobile device operates a virtualized architecture based upon a Hypervisor type 1 software module adapted for the creation and management of several virtualized independent partitions.

6. The security system according claim 5, wherein said virtualized architecture comprises:
(i) said Supervisor type 1 software module running on said mobile device bare machine, adapted for creating and managing said three separated partitions: the enterprise partition, the personal partition and the generic partition, each of said separate partitions running its own operating system;
(ii) common local support services on the mobile device; and
(iii) a trusted platform module (TPM) package in charge of secure storage and processing of cryptographic material comprising encryption keys and security certificates.

7. The security system according claim 5, wherein said common services comprise one or more of the following services: mobile device management (MDM) services, mobile applications management (MAM) services, mobile content management (MCM) services, a mobile applications dispatcher/broker module, baseband application services, firmware-over-the-air (FOTA) wireless communication services, intrusion detection/intrusion prevention services (IDS/IPS), antivirus services and encryption/decryption services for the traffic over the wireless communication channels and for the locally stored sensitive data.

8. The security system according to claim 3, wherein the Virtualized operating environment precludes the transfer of data between any application and the operating system.

9. The security system according to claim 3, wherein the partition software component precludes the transfer of data between applications residing in different virtualized partitions.

10. The security system according to claim 1, wherein the MDM, MAM, MCM software modules and the application dispatcher module in the enterprise partition are controlled by enterprise resources outside the mobile device.

11. The security system according to claim 1, wherein the application dispatcher module in the personal and generic/entertainment partitions is controlled by a dashboard personal application management package residing in the mobile device.

12. The security system according to claim 1, wherein said mobile device is a telephone, a smartphone, a tablet computer, a laptop computer, a Personal Digital Assistant (PDA) or a portable gaming console.

13. The security system according to claim 1, further comprising secure communication channels from the personal and generic partitions to a Personal/Generic Mobility Management component located in a personal cloud that ensures early detection, report and mitigation of external security, privacy and regulatory compliance threats and enforces the Personal Security Policy for the outbound Internet traffic.
